(19) United States
(12) Patent Application Publication
(10) Pub. No.: US 2007/0239583 A1
(43) Pub. Date: Oct. 11, 2007

(54) System and method for providing income via retirement income certificates

(75) Inventor: John Spencer Williams, Sturbridge, MA (US)

Correspondence Address: GOODWIN PROCTER LLP, 901 NEW YORK AVENUE, N.W., WASHINGTON, DC, 20001, US

(73) Assignee: Massachusetts Mutual Life Insurance Company, Springfield, MA (US)

(21) Appl. No.: 11/397,850

(22) Filed: Apr. 5, 2006

(51) Int. Cl. G06Q 40/00

(52) U.S. Cl. 705/36 R

(57) ABSTRACT

A system and method for providing at least one participant with at least a predefined, periodic income payment. The method comprises the step of designating at least one income-generating fund to generate distributable income. Next, the method comprises the step of issuing at least one self-liquidating and transferable denominated security in the at least one income-generating fund to at least one participant, the at least one transferable denominated security being denominated in units of periodic income. The method may also comprise the step of distributing at least one unit of the distributable income to the at least one participant according to respective particulars of the at least one transferable denominated security, wherein the at least one unit of distributable income comprises a floor portion and, if the at least one income-generating fund over-performs, an additional income portion.

### FIELD OF THE INVENTION

This application relates to systems and methods for issuing retirement income certificates, and more particularly to systems and methods for issuing retirement income certificates that mature at a future date, are denominated in units of periodic income, and that enable a purchaser to convert accumulated assets and/or periodic savings into a series of periodic income payments.

### BACKGROUND OF THE INVENTION

Post-employment income planning, particularly in retirement, is a daunting and challenging task. Among many things, an individual must consider and account for numerous contingencies to ensure a sufficient and reliable income stream, particularly in retirement. In fact, to achieve and maintain a desired lifestyle after they stop earning income from employment, an individual must be able to accurately forecast (or as close thereto as possible) his or her cost-of-living expenses and increases, unexpected expenses, such as medical and other emergencies, how long he or she will live, and other numerous speculative factors. Furthermore, given the rapidly rising costs-of-living and the fact that humans are living longer, healthier lives, it is paramount that post-employment income planning begin as early as possible in one's working life.

Income planning also involves addressing risks that must be resolved in order for a person to secure post-employment income that sufficiently replaces his or her working life's periodic income, a benchmark known in the financial services industry as a “replacement ratio.” Liquidity risk, for example, is risk that an individual faces when a financial instrument (e.g., an investment product) is illiquid and cannot be readily converted to cash, such as might be necessary when the owner's personal circumstances or needs change. Longevity risk is the risk that an individual will outlive his or her accumulated savings. Conversion risk is the risk that an owner cannot easily convert his or her accumulated or periodic savings into a personalized, defined periodic income stream payable at a future date. Inflation or cost-of-living risk is the risk that an owner's periodic income stream will not keep up with the cost of inflation. Market risk is the risk that an owner's accumulated savings will depreciate in value if exposed to the fluctuations observed in the equity and debt markets. Plan sponsor/creditor risk is the risk that an owner faces with a defined benefit plan or pension that is subject to the claims-paying ability of the owner's employer.

Numerous financial products have been developed to address some of these potential risks and thereby streamline the post-employment income planning process. Existing products include open and closed-end mutual funds, bonds, immediate annuities, guaranteed living benefit riders on deferred annuities, and exchange traded funds (“ETF”). Specific embodiments of existing financial products are described in the following pending patent applications:

U.S. Patent Application Publication No. 2005/0234821 (the “'821 published application”) discloses a method for administering an annuity-based retirement funding in which an investor's funds or current income is used to make incremental purchases of immediate annuity benefits at market rates, with the annuity payments received from previous purchases being applied to purchase additional annuity benefits. The investor allocates a first allocated portion of each received benefit into an account and the reinvested funds are thereafter available in combination with new investment payments from the investor for the purchase of additional immediate annuity benefits. At the direction of the investor, typically after retirement, all or part of the received annuity payments can be received for the use of the investor.

U.S. Patent Application Publication No. 2004/0177022 (the “'022 published application”) discloses a method of issuing and managing investment instruments called “Pension Shares” which preferably take the form of securities that represents a claim against and is secured by an investment fund. A Pension Share entitles its holder to receive, at a specified maturity date, either a lump sum payment amount or, at the option of said holder, to receive a sequence of annuity payments. The Pension Share issuer creates and manages the investment fund such that its net asset value at the maturity date will be adequate to make the lump sum payment or provide the holder with the annuity. A preferred form of Pension Share provides an annuity option of one dollar per for the life of the holder, or his or her survivor, both of whom are at a predetermined age at the maturity date. A Pension Share may be redeemed on demand in advance of the maturity date so that it may be exchanged for a Pension Share having a different maturity date if the holder's plans change.

While current products have improved the post-employment income planning process, they nonetheless suffer from several notable limitations. For example, current products do not provide an individual with a transferable financial or investment product that is denominated in units of periodic income and which may benefit from the self-liquidating attributes of an underlying investment fund or funds, i.e. periodic income payments made during the benefit period may consist of both earnings and return of principal, as calculated to result in the investment fund having a zero ending balance in dollars, at the specified ending date. Further, current products do not provide a record-keeping or administration system that (1) enables and facilitates transferability of a financial or investment product, (2) enables the manufacture and distribution of the various financial products and services described herein, and/or (3) further combines the ownership record-keeping function of a transfer agency system with the administrative functionality of an annuity record-keeping and payment system. In addition, current products do not provide the periodic valuation and publication of a price or value of an investment product that is denominated in units of periodic income and which may benefit from the self-liquidating attributes of an underlying investment fund or funds.

The financial products disclosed by the above applications suffer from other specific limitations. The '821 application, for example, specifically relates to annuities, which, unlike the systems and methods described herein, are not: (1) transferable, (2) security products (e.g., a listed security), and (3) freely liquid, but rather are liquid only to the extent allowed by the issuer. The '022 application relates to “pension shares,” which, in contrast to the systems and methods described herein, are: (1) not accumulation and payout products, but rather mere accumulation products that (a) may be redeemed with the issuer for a lump sum, (b) as expressly stated in the '022 application, may be preferably exchanged with the issuer for another like product, or (c) may allow the exercise of an option to potentially receive a sequence of annuity payments, (2) only applicable to qualified assets, (3) not transferable from one independent owner to another independent owner without redemption or change in the underlying fund, (4) not priced by the market (e.g., value determined by independent and willing buyers and sellers), (5) necessarily part of a defined contribution plan and cannot exist independently or in any other investment structure or product, such as an IRA, for example, and (6) not self-liquidating (e.g., a pension share does not return principal and earnings).

These and other problems exist.

### SUMMARY OF THE INVENTION

An object of the present invention is to overcome the aforementioned and other drawbacks existing in prior art systems and methods.

According to various embodiments, the systems and methods described herein may be used to create, issue and monitor the ownership, and facilitate the transfer from one owner to another of an income product referred to as a retirement income certificate (“RIC”) that provides a buyer with a specified periodic (e.g., monthly) income in a denominated amount (e.g. one dollar per month for 30 years) as a floor with the possibility of increases in income based on the performance of the underlying fund or funds. In some embodiments, the retirement income certificate, or RIC, may provide the periodic income for life or a specified term of years at the purchaser's choice. In some embodiments, the period of time during which the periodic income is received may be referred to as the benefit period. In some embodiments, the product may be marketed as a denominated security to assist in the broad distribution of the product through many well recognized distribution channels and may be listed on a national exchange. In some embodiments, the security instrument may be distributed as units of future income (which may or may not be guaranteed) to assist persons in reaching their “replacement ratio” goals, and the investment fund underlying the security may be managed to meet the obligations conferred by the RIC or security.

In some embodiments, proceeds from the primary sale of each issuance of RICs to persons or companies may be deposited into an investment fund and invested by the issuer in a manner designed to provide the owners with the benefits and options conferred at issuance. The investment fund backing the RICs may be self-liquidating, i.e. periodic income payments made during the benefit period will consist of both earnings and return of principal, as calculated to result in the investment fund having a zero ending balance in dollars, at the specified ending date. In some embodiments, the holder or beneficiary of a RIC does not need to initiate an option to receive the periodic income payments during the benefits period. Any over-performance of the underlying fund(s) may of course be paid to the holder or beneficiary of the RIC, either throughout the benefit period or, in some embodiments, in the form of a final or terminal payment.

In some embodiments, a RIC may be transferred through securities clearing entities, such as DTCC or NSCC, for example, from an initial owner to a different owner in any or all of the secondary (e.g., publicly-traded) markets for such transferable securities in the United States. RICs may be issued in one or more series and/or classes and each series/class may be issued with the corresponding benefits, options, rights and/or privileges. The combinations of the benefits and options may be determined by demand from the buying persons or company (initial or secondary) and administered by a computer system specifically designed to support those selected features.

The following is an example of a transaction involving RICs and the various systems and methods described herein. In 2006, an individual—Mr. Smith—is approaching retirement, projected to be Dec. 31, 2015. Mr. Smith has accumulated $500,000 currently invested in a mix of stock and bond mutual funds. Mr. Smith recognizes that he will no longer be receiving a monthly paycheck upon retirement and that he and his spouse need to provide for recurring living expenses that are currently estimated at $3,000 per month.

Mr. Smith calls his broker and asks him to sell his mutual funds and to use as much of the proceeds he requires to purchase RICs that meet his objective. Mr. Smith further instructs his broker to purchase RICs that have a cost-of-living (“COLA”) protection option, that are fully guaranteed, that have a maturity date (e.g., date of first benefit payment) of Jan. 1, 2016 and an expiration date of Dec. 31, 2045 (e.g., the Benefit Period is 30 years).

$250 million of RICs that mature Jan. 1, 2016 and expire Dec. 31, 2045 were first issued in 2005 in a public offering and are listed on the New York Stock exchange. At that time, the $250 million was deposited into an investment fund and managed so that the $250 million would be certain to provide the aggregate benefits promised to the then-owners of the COLA-Protected, Guaranteed RICs.

Mr. Smith's broker places the order for $3,000 per month (the “denominated amount”) maturing in 2016 and executes a purchase for Mr. Smith's brokerage account, using $410,000 (See FIG. 6—the first 10 years comprise the accumulation period, while the last 30 years comprise the guarantee or benefit period). As shown in FIG. 6, the beginning assets were $410,000 which is used to purchase a single series/class of RIC that in year 11 pays the owner $3000 per month. This translates into a purchase rate of $136.67 for every dollar of monthly benefit that they were going to get starting in year 11 (e.g., $410,000 divided by $3,000). This represents a way the RIC may be priced to the customer, i.e., the buyer gave the issuer $136.67 for every dollar of benefit to be received in the future.

The issuer may invest the $410,000 in whatever way he or she sees fit. In the example of FIG. 6, the issuer invests 60% in equity and 40% in fixed income. The 60% of the $410,000 is projected to earn an annual equity return of 7%, while the 40% fixed income portion is projected to earn an interest rate of 5% per year. The inflation rate of 2% refers to the COLA-protection option that is associated with the RIC. In year 1, the returns on the equity and fixed income investments amount to $25,420, which brings the asset amount at the end of year 1 to $435,420. This happens every year for ten years. Thus, before the first benefit is paid out, the underlying fund(s) has generated a total asset of $748,220 at the end of ten years.

At year 11, benefits start being paid and the costs associated with the COLA-protection start being incurred by the issuer. The $44,657 COLA payout of year 11 actually represents ($3000 per month times 1.02¹⁰). For example, dividing $44,657 by twelve results in the amount of $3721.41, of which $3000 is the benefit and $721.41 is the COLA payout (e.g., an inflation-adjusted payment). The $44,761 is subtracted because it is paid to the owner. The following narrative is provided to exemplify the self-liquidating nature of the RIC: depending on the then prevailing performance of the underlying fund and the cost basis of the fund's investments, a portion of the $44,761 benefit paid to the owner may be a return of principal and a portion may be earnings generated by the fund. Thus, in the example, the end assets increased by just under $2000 from the beginning assets of year 11. This process continues for the next 30 years. If the investments continue to perform as assumed, the balance at the end of the benefit period (e.g., end of year 40) will be close to zero. As shown, the balance of $623 is the over-performance of the RIC, which in some cases may be paid to the owner of the RIC. In some embodiments, the issued RIC may be closed at the end of year 40.

Back to the hypothetical, in 2025 Mr. Smith dies leaving his spouse his entire estate, including a fully-paid up life insurance policy for $1,000,000. Mrs. Smith decides that she no longer needs the RICs Mr. Smith purchased in 2006, since she will live off the life insurance proceeds, and instructs her broker to sell them on the NYSE at the then-prevailing price. Her broker places the order and a buyer pays $719,000 [See Year 20 on FIG. 6], with the proceeds being deposited into Mrs. Smith's brokerage account. The new owner, has purchased RICs with the remaining benefits and the same options as Mr. Smith; the new owner will begin receiving $4,547 per month [the original $3,000 adjusted for inflation results in $4,547 in Year 20] for the remaining 20 year life of the RIC, with the payments ceasing on Dec. 31, 2045. As further described herein, some or all of the above events, transactions, and changes may be duly recorded and executed by the various systems and methods described herein.

According to various embodiments of the invention, a method for providing at least one participant with at least an income payment is provided. The method comprises the steps of: designating at least one income-generating fund to generate distributable income; issuing at least one self-liquidating and transferable denominated security in the at least one income-generating fund to at least one participant, the at least one transferable denominated security being denominated in units of periodic income; and distributing at least one unit of the distributable income to the at least one participant according to respective particulars of the at least one transferable denominated security, wherein the at least one unit of distributable income comprises a floor portion and, if the at least one income-generating fund over-performs, an additional income portion. In some embodiments, the floor portion may or may not be guaranteed.

In another embodiments, a system for providing at least one participant with at least an income is provided. The system comprises an security issuing processor for issuing at least one self-liquidating and transferable denominated security in at least one income-generating fund to at least one participant, the at least one transferable denominated security being denominated in units of periodic income; and an income distribution processor for distributing at least one unit of the distributable income to the at least one participant according to respective particulars of the at least one transferable denominated security, wherein the at least one unit of distributable income comprises a floor portion and, if the at least one income-generating fund over-performs, an additional income portion. In some embodiments, the floor portion may or may not be guaranteed.

In yet another embodiment, a system for issuing retirement income certificates to at least one participant is provided. The system comprises a client station for purchasing at least one self-liquidating and transferable retirement income certificate (RIC), the at least one transferable RIC being denominated in units of periodic income; and a retirement income certificate station in communication with the client station over a communications network for: (1) issuing, processing and monitoring the ownership of the at least one retirement income certificate, and (2) distributing at least one unit of the distributable income to at least one participant according to respective particulars of the at least one retirement income certificate, wherein the at least one unit of distributable income comprises a floor portion and, if at least one income-generating fund associated with the retirement income certificate over-performs, an additional income portion. In some embodiments, the floor portion may or may not be guaranteed.

### BRIEF DESCRIPTION OF THE DRAWINGS

FIG. 1 illustrates the functionality of a RIC, according to one embodiment of the systems and methods described herein.

FIG. 1a illustrates various transactions involving RICs, according to one embodiment of the systems and methods described herein.

FIG. 2 illustrates a system 200 for providing creating, issuing and monitoring RICs, according to one embodiment of the systems and methods described.

FIG. 3 illustrates various exemplary modules associated with the RIC station 205 of FIG. 2, according to one embodiment of the systems and methods described.

FIG. 4 illustrates a method 400 for issuing and processing a RIC, according to one embodiment of the systems and methods described herein.

FIG. 5 illustrates a method 500 for providing at least one participant with at least an income, according to one embodiment of the systems and methods described herein.

FIG. 6 illustrates a table 600 showing data and information related to an individual's purchase of a RIC, according to one embodiment of the systems and methods described herein.

### DETAILED DESCRIPTION OF THE INVENTION

Reference will now be made to the present preferred embodiments of the invention, examples of which are illustrated in the accompanying drawings in which like reference characters refer to corresponding elements.

The present invention is described in relation to a system and method for issuing, processing, monitoring and facilitating the transfer of ownership of RICs. Nonetheless, the characteristics and parameters pertaining to the system and method may be applicable to transactions associated with other types of products, financial or otherwise.

While it may be appreciated that the systems and methods described herein may be used for virtually any life-stage income needs, for illustrative purposes the disclosure provided herein refers to retirement income planning as a preferred embodiment of the systems and methods described.

While the exemplary embodiments illustrated herein may show the various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system. Thus, it should be appreciated that the components of the various embodiments may be combined into one or more devices or collocated on a particular node of a distributed network, such as a telecommunications network, for example. As will be appreciated from the following description, and for reasons of computational efficiency, the components of the various embodiments may be arranged at any location within a distributed network without affecting the operation of the respective system.

Among many potential uses, the systems and methods described herein may be used to: (1) create and issue a series of retirement income certificates (“RIC's”) (e.g., securities) that mature at a future date, are denominated in units of periodic income, and enable a buyer to convert their accumulated assets and/or periodic savings into a secure periodic retirement income (e.g., a personal defined benefit plan); (2) monitor trades or sales of RIC's over a marketplace; (3) allow the buyer to specify RIC denomination (e.g., retirement income); (4) manage and administer the creation and issuance of RIC's; (5) track ownership of issued RIC's, including specific options, benefits, beneficiaries and processing provisions for the various features and functionality described herein; (6) monitor regulatory rules and laws related to creation and issuance of RIC's; (7) monitor tax status and bases of RIC's; (8) generate and deliver RIC reports to owners, beneficiaries, regulators and/or management; (9) process and calculate payments to RIC beneficiaries; (10) handle the trading of the underlying investment funds and fund trading for participating RIC accounts; (11) process pricing and other factors used to value individual RIC's as well as assets owned by participating accounts; (12) calculate, model and track investment fund assets and product liabilities; and (13) facilitate the transfer of RIC ownership. Other uses are possible.

According to various embodiments, the systems and methods described herein may be used to create and issue transferable RICs that may provide a purchaser, holder or beneficiary with a specified periodic (e.g., monthly) income in a denominated amount (e.g. dollar) as a floor with the possibility of increases in the income based on the performance of the fund. In some embodiments, the RIC may provide the periodic income for life or a specified term of years at the purchaser's choice. In some embodiments, RIC's may be marketed as a denominated security to assist in the broad distribution of the product through many well recognized distribution channels and may be listed on a national exchange. The security instrument may be distributed as units of future income and the security and the investment fund underlying the security may be managed to meet the obligations conferred by the security or RIC. A RIC owner may benefit from the self-liquidating attributes of a RIC's underlying investment fund or funds, i.e. periodic income payments made during the benefit period to a holder or beneficiary may consist of both earnings and return of principal as calculated to result in the investment fund having a zero ending balance in dollars at the specified ending date. In some embodiments, a RIC may be transferred from one owner to another owner at a price that is determined by the market (e.g., by independent and willing buyer and seller).

Further, in some embodiments, a single RIC may comprise corresponding associated accumulation and distribution or payout functions. For example, the buyer or holder of a RIC knows during the accumulation period the amount of periodic income he or she will be getting during the distribution or benefits period. That is, the benefits are defined when the RIC is purchased. In some embodiments, in addition to defining benefits, the resulting periodic income payments or payout may be guaranteed. This is in contrast to existing products, such as the “pension shares” of the '022 application described above, for example, that are mere accumulation products that do not have an embedded distribution function (that is, the holder of a “pension share” does not know the amount of periodic income he or she will be getting during the distribution period.) In contrast, a RIC is issued with a pre-defined accumulation and benefit period that provides the holder of the RIC a minimum periodic payment during the distribution or benefit period. In some embodiments, a RIC may be denominated with a periodic payment amount that indicates the amount to be received by the holder during the distribution or benefits period. Further, in contrast to the many existing products, such as the “pension share,” for example, the benefit/income payment element of the RIC is not an annuity. Individuals schooled in the art may recognize that such a product (i.e., RIC) and the systems and methods to support it do not presently exist in an “non-insurance” form. That is, an annuity is an insurance product whereas a RIC is not. In further contrast to the “pension shares” which may only be redeemed or exchanged with the issuer or enable the holder to exercise an option associated therewith, a RIC may be traded in a market where a price is set by a willing buyer and seller, thus eliminating any uncertainty as to the cost or value of a RIC.

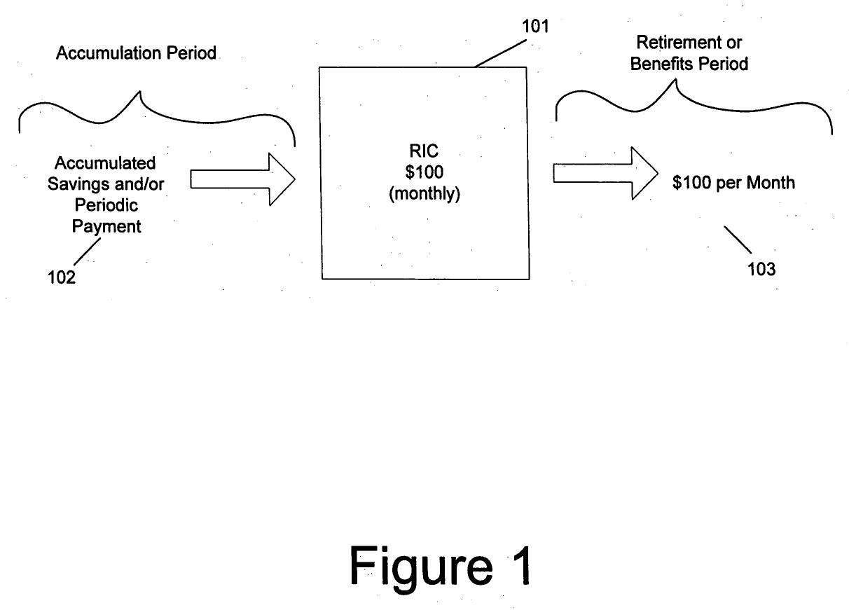

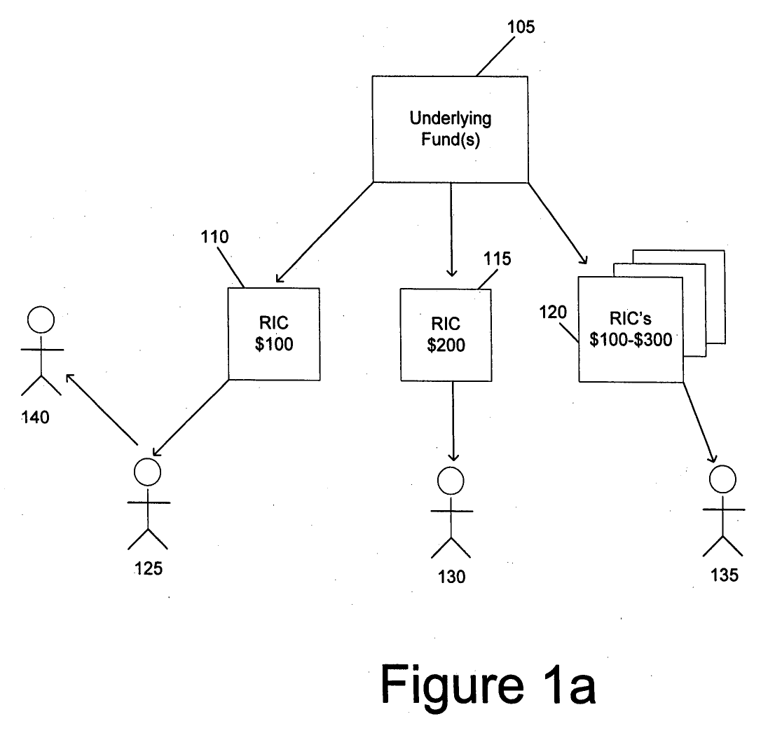

FIG. 1 illustrates the general functionality of a RIC as described herein. As shown, a purchaser may invest accumulated savings and/or periodic payments 102, during the accumulation period, to purchase a RIC 101 having a denominated value of $100 monthly, for example. In some embodiments, the accumulation period may comprise the period of time between the issuance of the RIC and when the benefit period starts. For example, in the case of a lump sum payment being paid by a buyer to purchase a RIC, the accumulation period may be brief, while in the case of periodic payments being made by the buyer to purchase the RIC the accumulation period may be longer (e.g., the period during which payments are made up until the benefit period). The total amount of accumulated savings (e.g., lump sum payment to the issuer) and/or periodic payments 102 may, in some embodiments, be dependent on the denominated value of the RIC and/or particulars of the accumulation and retirement or benefit periods. The issuer of RIC 101 may then invest the accumulated savings and/or periodic payments 102 in any number of investment funds in order to generate sufficient funds to be able make the specified payments 103 to holder or beneficiary of the RIC during the retirement or benefit period. In some embodiments, RIC ownership may be fully transferable from an initial owner to a secondary owner, for example, in any secondary market.

FIG. 1a illustrates a high-level perspective of various transactions that may be performed by the systems and methods described herein. As shown, there are three purchasers 125, 130 and 135 of RICs 110, 115, and 120, respectively, that correspond to at least one investment fund(s) 105. In some embodiments, a RIC may comprise a registered, transferable security purchased by individuals or companies that have a need to provide a secure, reliable and predictable periodic stream of income, such as for themselves, their survivors, beneficiaries, employees or other associated persons' retirement years. By purchasing a RIC the purchaser may easily convert accumulated savings and/or periodic payment into a secure periodic retirement income.

A RIC may be denominated in units of periodic income (e.g., dollars per month), with the periodic income beginning on a specified date in the future (e.g., the maturity date) and ending at a later specified date in the future (e.g., the expiration date). The period between the maturity date and the expiration date is defined as the benefit period. In some embodiments, a RIC may be issued in or more series and/or classes. In some embodiments, series may comprise or refer to the particular year a RIC is issued or the benefit period commences for any number of RICs, e.g., the time element of a particular RIC or RICs. For example, a 2021 series may refer to RICs whose benefits start being paid out in the year 2021. Similarly, a 2021 series may refer to RICs that were issued in the year 2021. In some embodiments, a class refers to RICs that have specified or particular corresponding options, benefits or privileges. For example, a 2020 series with a guarantee may refer to a class of RICs that start paying out with a guarantee in the year 2020. Likewise, a 2020 series without guarantee may refer to a class of RICs that are paid out without a guarantee starting in 2020. Similarly, a class of RICs may be rated, while other classes may be unrated. Other benefits and options may of course be specified by class. In some embodiments, an underlying fund(s) may be associated with various types of RIC series and/or classes.

In some embodiments, the combination of benefits, options and privileges associated with a RIC(s) may be determined on demand from the buying persons or company. In some embodiments, administration of RICs and corresponding benefits, options and privileges, may be performed by system(s) designed to support such benefits, options and privileges. Exemplary benefits of a RIC include, but are not limited to: (1) a transferable (e.g., liquid) security that can be sold to a new independent owner in a secondary market; (2) denomination in units of periodic income, e.g. dollars per month; (3) benefits (e.g., retirement income stream) paid to the owner with a specific periodicity during a retirement or benefit period, e.g. 30 years or until the death of the Owner; and (4) self-liquidation capabilities (e.g. the return of principal and earnings).

Exemplary options that may be available with a RIC include, but are not limited to:

(1) Cost-of-living (“COLA”)/inflation protection—the periodic adjustment of the income benefit indexed to a commonly-known measure of inflation. Application of the COLA option may result in an increasing periodic income payment to the owner as determined by formulaic use of a pre-defined measure of inflation.

(2) A full or partial benefit guaranty, including a “floor” guaranty—the guaranty may be with respect to the periodic income specified in the particular issue of the RIC, e.g. the RIC guaranties an owner $500 per month for the specified duration of the RIC. Following this example, the guaranty could be for the full benefit purchased by the owner, or alternatively, the guaranteed $500 per month could be a fraction of a denominated “face amount” of $1,000 per month, with the balance of $500 per month being exposed to market or investment risk. In some embodiments, guaranties may be provided by the issuer or alternatively by a single third-party or pool third-party of issuers (e.g., reinsurance).

(3) Rated Series, Class, or Issue, e.g. an independent entity engaged in the business of providing such ratings (e.g., Moody's, Standard & Poors, etc.) may assign a AAA rating, for example, to a particular issue or series of RICs.

(4) Full or partial deferral or reinvestment of current benefits in exchange for a specified/formulaic increase in future benefits. As an example, an owner could elect to not take a scheduled periodic payment(s) of their RIC benefit and instead reinvest the payment(s), thereby potentially increasing the value of future payment(s).

(5) Full or partial assignment of remaining interest at the death of the owner to the investment fund (“participating mortality option”) in exchange for a specified/formulaic increase in benefits during the benefit period.

(6) A participating interest in the performance of the investment fund above the amount required to meet the investment fund's benefit obligations (excess earnings), which may be an interest separate and apart from the rated RIC. For example, such participation would result in increases to benefits, periodic cash payments to owners, or a final payment to owners or beneficiaries at the termination of the investment fund. Other options are possible.

In some embodiments, a RIC may conform to the standards required by the Committee on Uniform Securities Identification Procedures (“CUSIP”) for issuance of a CUSIP number. A CUSIP number identifies most securities, including: stocks of all registered U.S. and Canadian companies, and U.S. government and municipal bonds. The CUSIP system—owned by the American Bankers Association and operated by Standard & Poor's—facilitates the clearing and settlement process of securities. The number consists of nine characters (including letters and numbers) that uniquely identify a company or issuer and the type of security. A similar system is used to identify foreign securities (CUSIP International Numbering System). A CUSIP number enables the RIC to be assigned, thereby permitting a purchaser or holder to transfer the RIC through securities clearing entities such as the Depository Trust & Clearing Corporation (DTCC) or the National Securities Clearing Corporation (NSCC). The securities clearing entity may transfer the RIC from an initial owner to a different owner in any or all of the secondary publicly-traded markets for such transferable securities in the United States or abroad.

As shown in FIG. 1a, RIC 110, denominated at $100 face value, is purchased by purchaser 125. Purchaser 110 may purchase RIC 110 by making a lump sum payment or by making a series of payments throughout a designated accumulation period. The lump sum payment or series of payments may be made to the issuer of RIC 110. Upon purcharing RIC 110, purchaser 110 would have an interest in those underlying funds 105 that correspond to RIC 110. In some embodiments, such interest may comprise the right to receive retirement or benefit payments totaling $100 per month throughout a designated retirement or benefit period.

Purchaser 130's interest in underlying funds 105 is similar to that of purchaser 125, except that he will be receiving $200 per month during the designated retirement or benefit period, as specified by RIC 115. In some embodiments, the underlying funds of RIC 115 and RIC 110 are the same, while in some embodiments they may be different. Likewise, particulars about the accumulation and retirement or benefit periods of purchasers 125 and 130 may be the same or they may be different.

Purchaser 135's interest in underlying funds 105 is similar to that of purchasers 125 and 130, except that he will be receiving various payments ranging from $100-$300 per month, as specified by RICs 120. In some embodiments, the underlying funds of RIC 115, RIC 110 and RICs 120 are the same, while in some embodiments they may be different. Likewise, particulars about the accumulation and retirement or benefit periods of purchasers 125, 130 and 135 may be the same or they may be different.

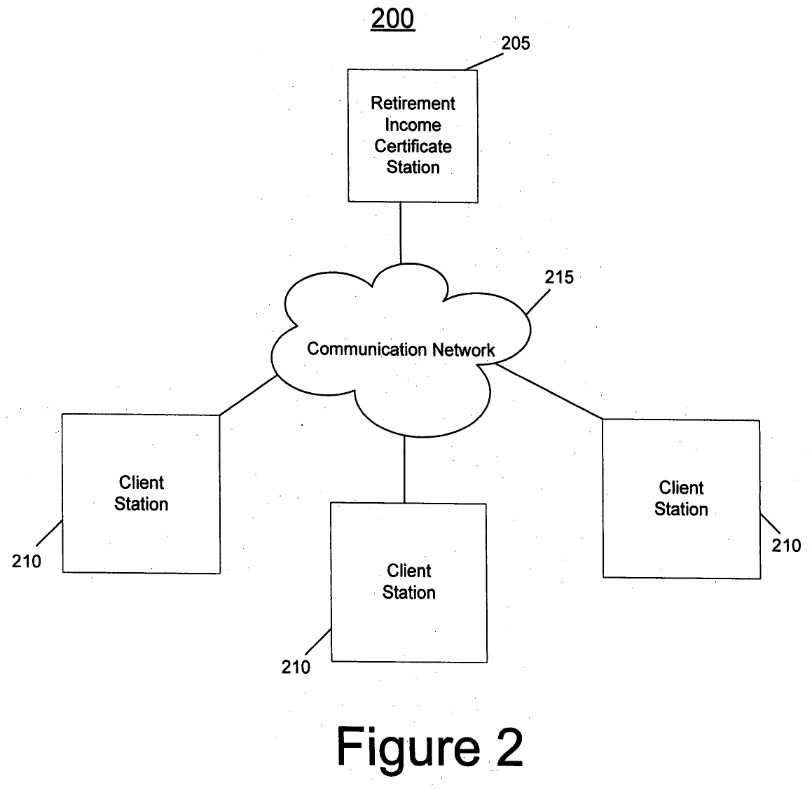

In some embodiments, either of purchasers 125, 130 or 135 may transfer (e.g., sell) his interest in their corresponding RICs in a secondary market to a second purchaser. For example, as shown in FIG. 1a, purchaser 125 may sell his RIC 110 in a secondary market to purchaser 140, who thereafter would obtain rights under the corresponding underlying funds (e.g., the right to receive benefit payments during the benefit period). Such a scenario might occur if purchaser 125 prefers immediate cash versus the RIC benefits and therefore decides to sell the RIC 110 to a new owner (e.g., purchaser 140) who would then get rights to the future payments in exchange for paying the RICs current value. In some embodiments, the sale of RICs from an initial owner to a new owner may be facilitated and administered by the various systems and methods described herein, such as system 100 described in FIG. 2, for example. Thus, by virtue of its transferability, RIC 110 effectively constitutes a security (or stock) in the corresponding underlying funds 105. Further, in some embodiments, the underlying investment fund or funds corresponding to RIC 110 may be self-liquidating, meaning that the periodic income payments made during the benefit period will consist of both earnings and return of principal as calculated to result in the corresponding investment funds having a zero ending balance in dollars at the specified ending date of the benefit period. In some embodiments, a RIC may be sold during its accumulation period. For example, if a RIC is sold during an accumulation period wherein periodic payments are made by the initial owner, a subsequent buyer may purchase the RIC from the initial owner and continue to make the periodic payments into the RIC. In some embodiments, valuation of a RIC occurs periodically (e.g., hourly, daily, weekly, monthly, etc.) throughout the lifetime of a RIC, which may include the RIC's IPO, the accumulation period, and the benefits period. The RIC valuation process may confer unique benefits to owners that improve upon the current art, by enabling the development of a transparent and frictionless secondary market for RICs, whereas current art/products largely require redemption or exchange with the issuer for a like product, for example.

FIG. 2 illustrates one embodiment of a system 200 for issuing and managing RICs, according to various embodiments of the systems and methods described herein. System 200 may include a retirement income certificate station (“RIC station”) 205 and at least one client station 210. The RIC station 205 and client stations 210 may all be connected through communications network 215.

RIC station 205 may comprise the processing station or center of an issuer of RICs, such as an investment bank, brokerage firm, or other financial institution, for example. Client station 210 may comprise the terminal or access point for purchasers, beneficiaries, administrators of RIC station 205, for example. Communications network 215 interconnects RIC station 205 and client stations 210 to enable communication and transfer of data and information Each is described in more detail below.

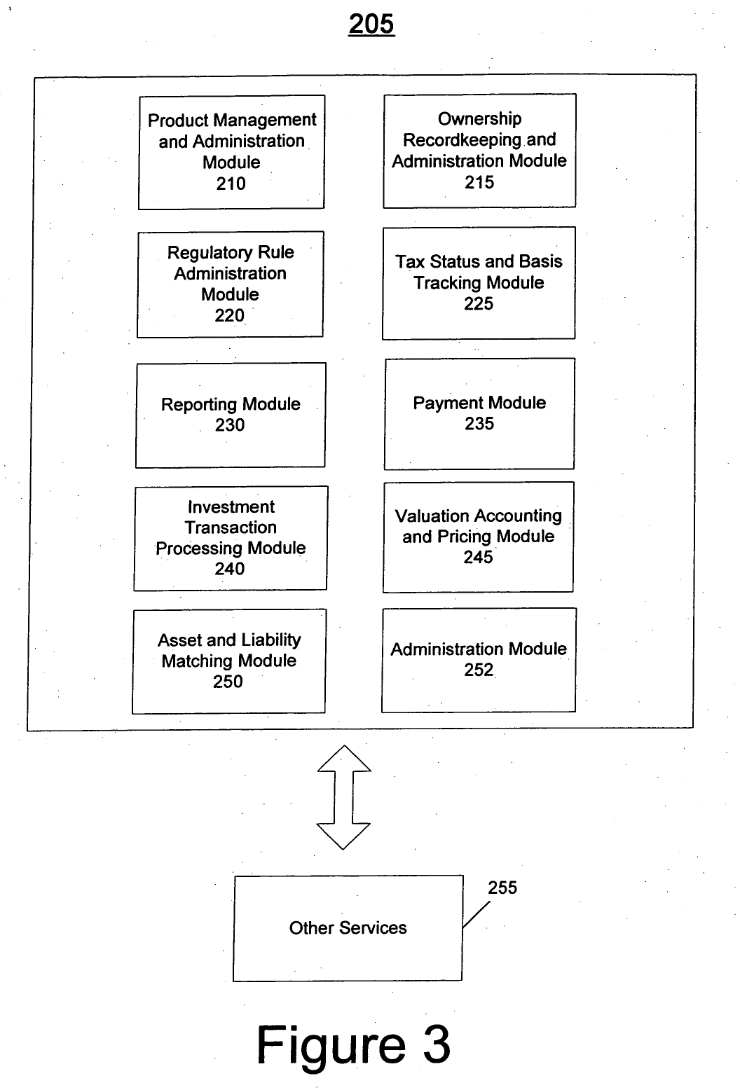

RIC station 205 may comprise a single server or engine (as shown). In some embodiments, RIC station 205 may comprise a plurality of servers or engines, dedicated or otherwise, which may further host modules for performing desired system functionality. RIC station 205, for example, may host one or more applications or modules that function to permit interaction between the users (e.g., buyers, owners, beneficiaries, sellers, financial institutions, and other parties) as it relates to the issuing, purchasing, trading or selling, for example, of RIC's. For instance, RIC station 205 may include an administration module that serves to permit interaction between the system and the individual(s) or entity(ies) charged with administering RIC station 205. RIC station 205 may further include module(s) for, among other things, tracking RIC ownership and specific options, benefits, beneficiaries, and other processing provisions for the features and functions described herein, for example. Other modules may permit users to reference RIC data and information, including, for example, denomination, maturity date, expiration date, and other terms and options (see FIG. 3 for exemplary modules that may be associated with RIC station 205).

RIC station 205 may include, for instance, a workstation or workstations running the Microsoft Windows™ XP™ operating system, Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

RIC station 205 may be operated and maintained by an issuer or its contract and service provider, for example, to issue RICS and to monitor ownership of issued RICs as effected by transactions over secondary markets. In some embodiments, an issuer may comprise any individual or entity. For example, an issuer may comprise an individual or company/business in the financial services industry, including but not limited to, retail banks, trust companies, investment banks, broker dealers, registered investment advisors, financial advisors, CPA firms, insurance companies, mutual fund companies, hedge funds, any type of investment manager, distributors of financial products, technology providers, third party servicing firms, governmental entities, and any other individual or entity offering retirement or income plans to their employees, including but not limited to, unions, and companies with pension plans or defined contribution plans, for example.

In some embodiments, the issuer may also monitor and process RIC-related particulars, such as regulations or rules affecting issued and circulating RICs, tax implications, and other like factors, for example. RIC station 205 may also generate and distribute reports to RIC owners, as well as administer and process investment transactions (e.g., administer changes in investments funds corresponding to issued RICs), administer valuation, accounting and pricing of issued RICs, and asset and liability matching. RIC station 205 may also maintain or interact with storage devices that maintain data and information used in connection with any of the features and functions performed by RIC station 205. In some embodiments, RIC station 205 may also comprise appropriate back-up and security systems to ensure reliability, privacy and integrity of the various features and functionality described herein.

Client stations 210 may comprise or include, for instance, a personal or laptop computer running a Microsoft Windows™ 95 operating system, a Windows™ 98 operating system, a Millenium™ operating system, a Windows NT™ operating system, a Windows™ 2000 operating system, a Windows XP™ operating system, a Windows CE™ operating system, a PalmOS™ operating system, a Unix™ operating system, a Linux™ operating system, a Solaris™ operating system, an OS/2™ operating system, a BeOS™ operating system, a MacOS™ operating system, a VAX VMS operating system, or other operating system or platform. Client stations 210 may include a microprocessor such as an Intel x86-based or Advanced Micro Devices x86-compatible device, a Motorola 68K or PowerPC™ device, a MIPS device, Hewlett-Packard Precision™ device, or a Digital Equipment Corp. Alpha™ RISC processor, a microcontroller or other general or special purpose device operating under programmed control. Client stations 210 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Client stations 210 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Client stations 210 may also include a network-enabled appliance such as a WebTV™ unit, a radio-enabled Palm™ Pilot or similar unit, a set-top box, a browser-equipped or other network-enabled cellular telephone, or another TCP/IP client or other device.

Client stations 210 may be used by a buyer, for example to interface with RIC station 205 input information or data in connection with purchasing a RIC, such as interacting with RIC station 205, for example. In one embodiment, for example, a buyer may interface with a graphical user interface (or GUI), for example, to input information through a predetermined form that queries for desired particulars on retirement, such as expected retirement date, benefits desired and length of benefit period, for example.

Communications network 215 may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection. Communications network 215 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 215 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

Communications network 215 may be used by a user of client station 210 or an administrator of RIC station 205, for example, to transmit or receive data or information relating to the issuance, purchasing, processing and monitoring of RICs. For instance, purchaser 125 of FIG. 1a may electronically submit information to an issuer in connection with the purchase of RIC 110, for example. Similarly, an administrator of RIC station 205 may use communications network 215 to transmit periodic reports to owners of RICs, interface with various external systems in connection with the various features and functionality described herein, or to process payments to beneficiaries of RICs, for example. Other uses of communications network 215 are of course possible.

FIG. 3 illustrates exemplary modules that may be associated with RIC station 205 for carrying out (or administering) the various functions and features of the embodiments described herein. In some embodiments, RIC station 205 may comprise a product management and administration module 210, an ownership recordkeeping and administration module 215, a regulatory rule administration module 220, a tax status and basis tracking module 225, a reporting module 230, a payment module 235, an investment transaction processing module 240, a valuation, accounting and pricing module 245, an asset and liability matching module 250, and an administration module 252. Other modules for performing the various and features and functionality of the systems and methods described herein may be provided. While the modules may not be used in all embodiments to perform some or all of the functions of the present invention, they are nonetheless presented as possible embodiments:

Product management and administration module 210 may, in some embodiments, manage and administer RIC product reference information, such as denomination, maturity date, expiration date, and other corresponding terms and options. In some embodiments, the product reference information may be used for the initial modeling of the portfolio and determination of RIC terms and options, initial offering, and all sales and marketing information including the prospectus. For example, particulars about the benefits or options of a RIC going through IPO may be published in prospectus to inform potential buyers. In some embodiments, product management and administration module may maintain records, parameters, characteristics, benefits, options, for example, associated with a series and/or class of RICs.

In some embodiments, product management and administration module 210 may be used by an issuer (or agent thereof) to create a particular RIC. Creation of a RIC may, in some embodiments, comprise a seven-step process: (1) identifying market needs (e.g., determine benefits and volume); (2) creating and modeling the underlying investment fund(s); (3) pricing the RIC; (4) registering the RIC with the appropriate regulatory agencies and departments; (5) publishing a preliminary offering document for sale to the public (e.g., a red herring); (6) issuing RICs in exchange for payment; and (7) ongoing management of RIC ownership and transferability as well as the other post-issuance features and functionality described herein. In some embodiments, any of the seven step-processes may be performed by an agent of the issuer, for example, via interaction with any number of interfaces provided via product management and administration module 210. Such interfaces may enable a user to provide and receive data and information related to creation process; interact with any individuals or entities that may be a part of the RIC-creation process; and/or monitor or track progress throughout the RIC-creation process. In some embodiments, product management and administration module 210 may also track particulars on specific options, benefits, beneficiaries and processing provisions for other system components.

Ownership recordkeeping and administration module 215 may, in some embodiments, track ownership of RICs as effected by initial and ongoing transactions occurring over a secondary market. In some embodiments, ownership recordkeeping and administration module 215 may maintain, develop or permit access to client/customer information and data as associated to particular issued RICs. For example, ownership recordkeeping and administration module 215 may associate owners and particular classes or series of RICs. Such associations may then be tracked and monitored by an agent of the administrator of RIC station 205, for example. Customer/client/owner information or data may comprise name, address, work, telephone number, or any other data or information that may uniquely identify a customer/client/owner.

Regulatory rule administration module 220 may, in some embodiments, process and track any regulatory rules or Internal Revenue Service (“IRS”) rules that need to be applied to the RIC product, such as required minimum distribution rule, for example. In some embodiments, regulatory rule administration module 220 may interact or communicate with various external rule or regulatory system(s) (e.g., government agencies) that generate or publish such information. For example, an administrator of RIC station 205, for example, may access regulatory rule administration module 220 to interact with such external rule or regulatory system(s). In some embodiments, regulatory rule administration module 220 may also receive data or information (e.g., rules or regulations) that is electronically submitted by such external rule or regulatory system(s). In some embodiments, regulatory rule administration module 220 may determine compliance with such rules or regulations.

Tax status and basis tracking module 225 may, in some embodiments, track the tax status of the RIC owner/beneficiary and/or the tax basis of the owner/beneficiary's interest. In some embodiments, tax status and basis tracking module 225 may enable an administrator of RIC station 205 to comply with all RIC-related tax reporting or accounting duties or obligations by maintaining an accurate accounting of tax-related aspects of RIC issuance, ownership and performance. For example, in some embodiments, tax status and basis tracking module 225 may track an owner's principal at the time of purchase versus any gains that may have been realized (e.g., is the issuer returning principal and/or interest, and/or dividends). This way, an administrator of RIC station 205 may properly report this performance to the proper tax agency or department and thereby comply with current tax rules and regulations, for example. In some embodiments, tax status and basis tracking module 225 may determine compliance with such tax rules or regulations, and may also issue reports to the appropriate recipients, such as agents of the issuer, customers/owners/beneficiaries, and/or governmental tax agencies or departments as may be necessary, for example.

Reporting module 230 may, in some embodiments, generate reports to owners of RICs, regulators, tax offices, governments, and any other individual or entity involved in the issuing, purchasing, processing, and monitoring, for example, of RICs as described herein. Exemplary reports include, but are not limited to periodic statements of account to the owner of a RIC, reports to tax and other government agencies, and reports to brokerage firms, for example. Other reports are of course possible.

Payment module 235 may, in some embodiments, generate periodic payments to the RIC beneficiaries, for example, drawing from the RIC account. For example, payment module 235 may perform all processing relating to the issuing of payments during a particular retirement or benefit period. In some embodiments, payment modules 235 may interface with the systems of a beneficiary's bank, for example, to ensure timely and proper payments as agreed.

Investment transaction processing module 240 may, in some embodiments, administer the trading of underlying investment securities, for example, for the investment portfolio(s) underlying the RIC. That is, investment transaction processing module 240 may administer and monitor trades associated with particular RICs. Thus, a manager of a fund underlying a RIC may interact with investment transaction processing module 240 to effect, monitor and track buys and sells for the fund. For example, on any given day a fund may comprise treasury bonds, index funds, or any other financial or investment product(s) that may be deemed by the fund manager to meet the obligations of an issued RIC. Investment transaction processing module 240 may also comprise the underlying record keeper and/or accounting system for the manager of a fund, maintaining data and information on trading, investments, collection of income and dividends, coupon clipping for bonds, crediting, settlement, clearance, and any other function that may be performed by the manager in connection with an underlying fund.

Valuation, accounting and pricing module 245 may, in some embodiments, value, maintain accounting for, and price individual RICs. In some embodiments, the valuation function may comprise the periodic (e.g., hourly, daily, weekly, monthly, etc.) valuing of the obligations of individual securities, for example, that comprise an underlying fund. The values associated with the securities may then be used to price the RIC(s) that correspond to the underlying fund. Accounting may comprise the periodic processing of debits and credits against the underlying fund. For example, an interest payment received on a bond may be credited to the fund, whereas a dividend or expense may comprise a debit. Pricing may comprise taking the valuation, matching it with the account, and generating and assigning a unit value for each of the benefits of issued RICs. In some embodiments, a unit value is assigned to each RIC within a series or class. For example, a RIC that has a guarantee may have a different price than a similar RIC without the guarantee because the fund is being charged for the cost of the guarantee (e.g., capital is transferred to a reinsurance entity). In some embodiments, valuation, account and pricing module 345 may interface with an external electronic pricing service, for example, to obtain relevant data or information used in the valuation, account and pricing functions.

Asset and liability matching module 250 may, in some embodiments, calculate, model and track investment fund assets and product liabilities. For example, asset and liability matching module 250 may look at the asset side (e.g., the assets that are performing and intended to pay future benefits) and make sure the assets' expected performance/cash flow (e.g., the investment gains and earned income) matches in terms of the amount and timing of the fund's liabilities (i.e., the periodic income payments defined in the RIC). Thus, a fund manager may interact with asset liability matching module 250 to evaluate whether the assets are performing in a desired manner. In some embodiments, asset and liability matching module 250 may process performance particulars of the underlying fund and determine whether liabilities are likely to be met.

Other services 255 may, in some embodiments, comprise any external services that may cooperate with RIC station 205 in connection with issuing, processing and monitoring circulating RICs, such as, for example, an electronic payment service, an electronic clearing service, or an electronic pricing service. Other services are possible.

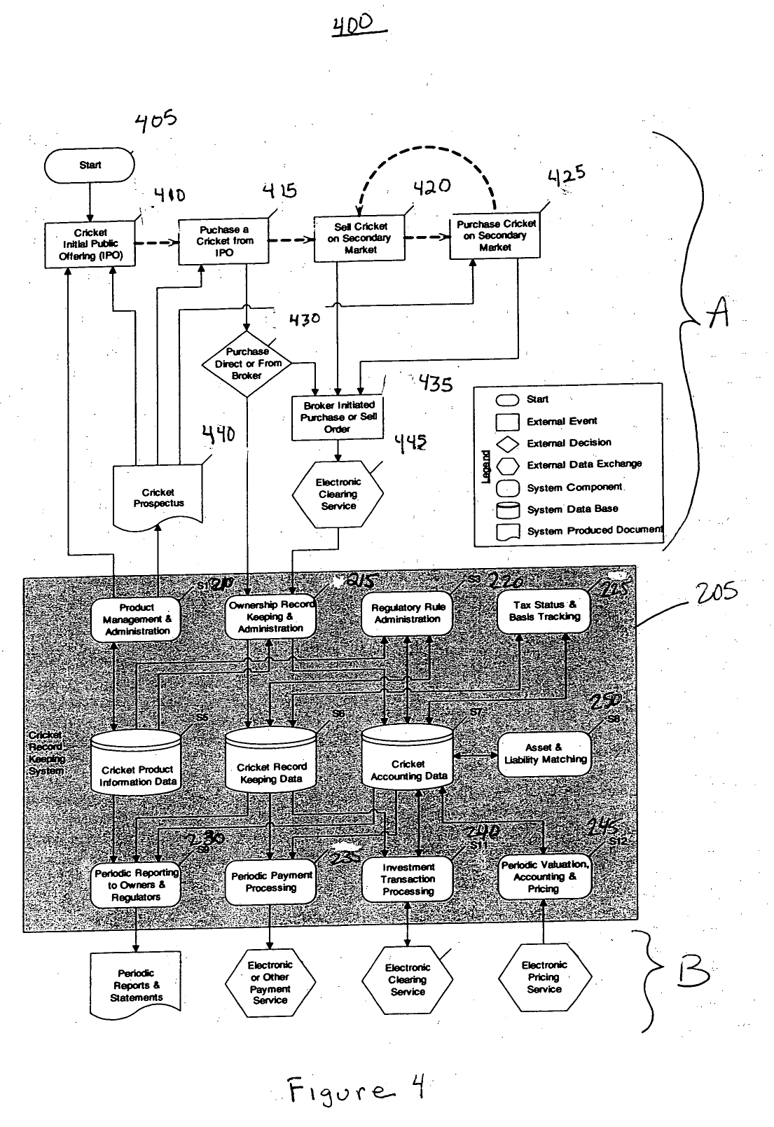

FIG. 4 illustrates a process flow 400 depicting one embodiment of the inter-operation of the modules set forth in FIG. 3. More specifically, FIG. 4 illustrates one embodiment of the interaction between external events A and B and the various modules of RIC station 205 in connection with the issuing and processing or RICs. As shown, process flow 400 may comprise the life cycle of an RIC product. At step 410, the initial public offering (“IPO”) of a series of RICs, for example, may take place. An IPO is the first sale of RICs by a private company, such as any issuer, for example, to the public. In the IPO, the issuer may obtain the assistance of an underwriting firm, which helps it determine what type (e.g., series or class) of security to issue, best offering price and/or time to bring it to market. In some embodiments, there may be multiple RIC issues by one or more issuers, for example, with each issuer issuing one or more series or classes of RICs. Each series of RICs, for example, may have a RIC prospectus 440 that describes the RIC product including all provisions and options. The prospectus 440 may be referenced by an individual, corporation, trust, IRA, etc., for example, in determining whether to purchase the RIC. In some embodiments, the prospectus 440 may be produced by RIC station 205, and more specifically product management and administration module 210.

At step 415, a RIC may be purchased at the IPO from the issuer by an individual, corporation, trust, or IRA, or other entity, for example. In some embodiments, the RIC may be purchased directly from the issuer, for example, or from a broker, as shown in step 430. Following the initial purchase, a RIC may be transferred or sold via a secondary market as shown in steps 420 and 425. Transactions over a secondary market may be conducted directly with RIC station 205, or through a broker.

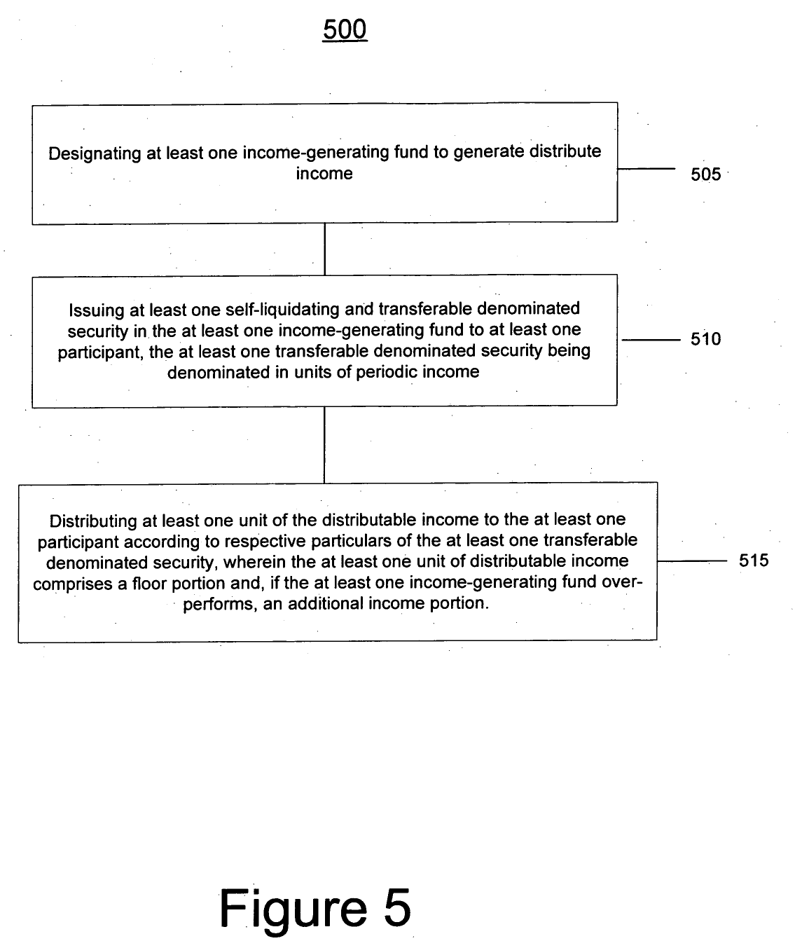

FIG. 5 illustrates a method for providing at least one participant with at least an income, according to one embodiment of the systems and methods described herein. At step 505, at least one income-generating fund is designated to generate distributable income. In some embodiments, the income-generating fund may be designated after a purchaser purchases at least one transferable denominated security that guarantees a minimum income during a designated retirement or benefit period. In some embodiments, the proceeds from the sale of the at least one transferable denominated security are invested in the at least one income-generating fund. At step 510, the at least one transferable denominated security in the at least one income-generating fund is issued to at least one participant. In some embodiments, the at least one participant may comprise the purchaser or a holder or beneficiary thereof, for example. At step 515, at least one unit of the distributable income is distributed to the at least one participant. In some embodiments, the distributable income is distributed during a designated benefit period, which may comprise the retirement period of the at least one participant.

As described herein, a RIC is a transferable security that provides a stream of income to its owner during their retirement years. As such, RICs have a wide range of applications for both individual and institutional owners. For example, an individual owner may purchase RICs through a brokerage account, an investment advisory account, a trust account, as part of a non-qualified plan, or any other form, such as an issued certificate that may be held in a safety deposit box, for example. An individual may also purchase RICs as part of a IRS-qualified purchase. For example, RICs may be purchased through: (1) a defined contribution (DC) plan (e.g., 401(k), 401(b), and 457) either as a DC investment option or as DC default investment; (2) a DC rollover to an IRA; (3) a IRA (Roth or other); or (4) a defined benefit (DB) (Pension) plan having a DC lump sum rollout or as a DC replacement. An individual may also purchase RICs as part of a certificate of deposit (“CD”) (e.g., bank-issued). Other examples of how individuals may purchase RICs are possible.

The following is an example of an individual purchasing a RIC:

### EXAMPLE

### Individual Owner Ordinary Purchase in a Brokerage Account

It is 2006 and an individual—Mr. Smith—is approaching retirement, projected to be Dec. 31, 2015, and has accumulated $500,000 currently invested in a mix of stock and bond mutual funds. Mr. Smith recognizes that he will no longer be receiving a monthly paycheck upon retirement and that he and his spouse need to provide for recurring living expenses that are currently estimated at $3,000 per month.

Mr. Smith calls his broker and asks him to sell his mutual funds and to use as much of the proceeds he requires to purchase RICs that meet his objective. Mr. Smith further instructs his broker to purchase RICs that have a COLA-Protection option, that are fully guaranteed, that have a maturity date (e.g., date of first benefit payment) of Jan. 1, 2016 and an expiration date of Dec. 31, 2045 (e.g., the Benefit Period is 30 years).

$250 million of RICs that mature Jan. 1, 2016 and expire Dec. 31, 2045 were first issued in 2005 in a public offering and are listed on the New York Stock exchange. At that time, the $250 million was deposited into an investment fund and managed so that the $250 million would be certain to provide the aggregate benefits promised to the then-Owners of the COLA-Protected, Guaranteed RICs.

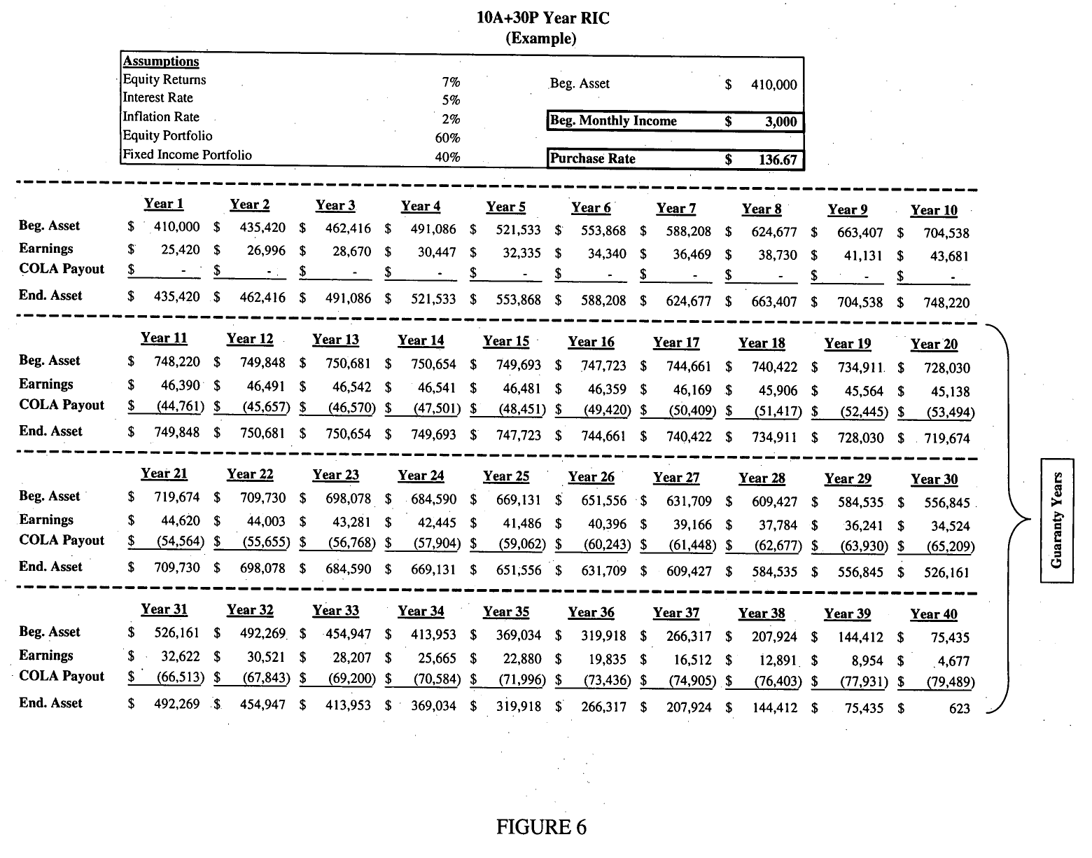

Mr. Smith's broker places the order for $3,000 per month maturing in 2016 and executes a purchase for Mr. Smith's brokerage account, using $410,000 (See FIG. 6—the first 10 years comprise the accumulation period, while the last 30 years comprise the guarantee or benefit period). As shown in FIG. 6, the beginning assets were $410,000 which is used to purchase a single series/class of RIC that in year 11 pays the owner $3000 per month. This translates into a purchase rate of $136.67 for every dollar of monthly benefit that they were going to get starting in year 11 (e.g., $410,000 divided by $3,000). This represents a way the RIC may be priced to the customer, i.e., the buyer gave the issuer $136.67 for every dollar of benefit to be received in the future.

The issuer may invest the $410,000 in whatever way he or she sees fit. In the example of FIG. 6, the issuer invests 60% in equity and 40% in fixed income. The 60% of the $410,000 is projected to earn an annual equity return of 7%, while the 40% fixed income portion is projected to earn an interest rate of 5% per year. The inflation rate of 2% refers to the COLA-protection option that is associated with the RIC. In year 1, the returns on the equity and fixed income investments amount to $25,420, which bring the asset amount at the end of year 1 to $435,420. This happens every year for ten years. Thus, before the first benefit is paid out, the underlying fund(s) has generated a total asset of $748,220 at the end of ten years.

At year 11, benefits start being paid and the costs associated with the COLA-protection start being incurred by the issuer. The $44,657 COLA payout of year 11 actually represents ($3000 per month times 1.02¹⁰). For example, dividing $44,657 by twelve results in the amount of $3721.41, of which $3000 is the benefit and $721.41 is the COLA payout (e.g., an inflation-adjusted payment). The $44,761 is subtracted because it is paid to the owner. The following narrative is provided to exemplify the self-liquidating nature of the RIC: depending on the then prevailing performance of the underlying fund and the cost basis of the fund's investments, a portion of the $44,761 benefit paid to the owner may be a return of principal and a portion may be earnings generated by the fund. Thus, in the example, the end assets increased by just under $2000 from the beginning assets of year 11. This process continues for the next 30 years. If the investments continue to perform as assumed, the balance at the end of the benefit period (e.g., end of year 40) will be close to zero. As shown, the balance of $623 is the over-performance of the RIC, which in some cases may be paid to the owner of the RIC. In some embodiments, the issued RIC may be closed at the end of year 40.

Back to the hypothetical, in 2025 Mr. Smith dies leaving his spouse his entire estate, including a fully-paid up life insurance policy for $1,000,000. Mrs. Smith decides that she no longer needs the RICs Mr. Smith purchased in 2006, since she will live off the life insurance proceeds, and instructs her broker to sell them on the NYSE at the then-prevailing price. Her broker places the order and a buyer pays $719,000 [See Year 20 on FIG. 6], with the proceeds being deposited into Mrs. Smith's brokerage account. The new Owner, has purchased RICs with the remaining benefits and the same options as Mr. Smith; the new Owner will begin receiving $4,547 per month [$the original $3,000 adjusted for inflation results in $4,547 in Year 20] for the remaining 20 year life of the RIC, with the payments ceasing on Dec. 31, 2045.

In some embodiments, all of the above events, transactions, and changes may be duly recorded and executed in RIC station 205, for example.

An institution may purchase RICs in connection with its role as a corporate/plan sponsor. For example, the corporate/plan may purchase RICs as part of a defined contribution company match; a bulk-buy for future distribution; a defined benefit replacement; or a defined benefit rollout option. Other examples of how institutions may purchase RICs are possible.

The following is an example of an institution purchasing a RIC:

### EXAMPLE

### Institutional Owner Defined Contribution Match

It is 2006 and ABC Company has determined that they will match up to 5% of their employees' salaries in contributions to their 401(k) Plan. Beginning with their regularly scheduled January 4th payroll, ABC Company calculates that their matching contribution totals $250,000 and that their employees demographic profile is such that it desires to purchase equal amounts of RICs in the secondary market for employees that will retire beginning in 2015 and every year thereafter through 2040.

ABC Company instructs their Plan Administrator to purchase $10,000 each of the 25 different RICs series that mature in 2015-2040. The Plan Administrator executes the 2015 purchase for $10,000 and buys a monthly income benefit of $73 for the 2015 RIC, which is subsequently deposited to the designated employees' 401(k) accounts. Each payroll period thereafter, ABC Company executes a similar program of systematic purchase of RICs and at the end of the 2006, the group employees in the 2015 retiring group has accumulated $1,898 of monthly income.

Consistently executed over a number of working years, ABC Company's employer-matching of 401(k) contributions will result in it retirees accumulating a significant monthly income benefit that can either be received for the Benefit Period or alternatively transferred to a new Owner, depending on the Owner's needs.

According to various embodiments, the transactions and exchanges of data or information described herein may be conducted in a secure and reliable manner, such as through known encryption and authentication techniques, for example. Other security techniques may be used.

Further, the various features and functionality described herein, including RIC station 205, for example, may be used by any individual or company/business in the financial services industry, including but not limited to, retail banks, trust companies, investment banks, broker dealers, registered investment advisors, financial advisors, CPA firms, insurance companies, mutual fund companies, hedge funds, all types of investment managers, and companies in the business of distributing financial products, technology providers and other third party servicing firms, governmental entities, and all other entities offering retirement plans to their employees, including but not limited to, unions, and companies with pension plans and defined contribution plans.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed:

1. A method for providing at least one participant with at least an income, the method comprising the steps of:
designating at least one income-generating fund to generate distributable income;
issuing at least one self-liquidating and transferable denominated security in the at least one income-generating fund to at least one participant, the at least one transferable denominated security being denominated in units of periodic income; and
distributing at least one unit of the distributable income to the at least one participant according to respective particulars of the at least one transferable denominated security, wherein the at least one unit of distributable income comprises a floor portion and, if the at least one income-generating fund over-performs, an additional income portion.

2. The method of claim 1 wherein the at least one transferable denominated security comprises a retirement income certificate (RIC).

3. The method of claim 2 wherein the RIC is associated with an accumulation period and a benefit period, defined at issue.

4. The method of claim 3 wherein the at least one unit of the distributable income is distributed to the at least one participant during the benefit period.

5. The method of claim 1 wherein the at least one unit of distributable income is indicated by the denominated value of the at least one transferable denominated security.

6. The method of claim 1 wherein the at least one participant comprises an individual, entity, IRA, or trust.

7. The method of claim 1 wherein the respective particulars of the at least one transferable denominated security comprises the denominated value of the denominated security, a maturity date and an expiration date.

8. The method of claim 1 wherein the a floor portion comprises a minimum payment.

9. The method of claim 8 wherein the minimum payment is guaranteed to a payee for a specified period of time.

10. A system for providing at least one participant with at least an income, the system comprising:
an security issuing processor for issuing at least one self-liquidating and transferable denominated security in at least one income-generating fund to at least one participant, the at least one transferable denominated security being denominated in units of periodic income; and
an income distribution processor for distributing at least one unit of the distributable income to the at least one participant according to respective particulars of the at least one transferable denominated security, wherein the at least one unit of distributable income comprises a floor portion and, if the at least one income-generating fund over-performs, an additional income portion.

11. The system of claim 10 wherein the at least one transferable denominated security comprises a retirement income certificate (RIC).

12. The system of claim 11 wherein the RIC is associated with an accumulation period and a benefit period.

13. The system of claim 12 wherein the at least one unit of the distributable income is distributed to the at least one participant during the benefit period.

14. The system of claim 10 wherein the at least one unit of distributable income is indicated by the denominated value of the at least one transferable denominated security.

15. A system for issuing retirement income certificates to at least one participant, comprising:
a client station for purchasing at least one self-liquidating and transferable retirement income certificate (RIC), the at least one transferable RIC being denominated in units of periodic income; and
a retirement income certificate station in communication with the client station over a communications network for: (1) issuing, processing and monitoring the ownership of the at least one retirement income certificate, and (2) distributing at least one unit of the distributable income to at least one participant according to respective particulars of the at least one retirement income certificate, wherein the at least one unit of distributable income comprises a floor portion and, if at least one income-generating fund associated with the retirement income certificate over-performs, an additional income portion.

16. The system of claim 15 wherein the RIC station is in communication with at least one securities clearing system regarding sales of the at least one RIC in secondary markets.

17. The system of claim 15 wherein the RIC is associated with an accumulation period and a benefit period.

18. The system of claim 15 wherein the at least one unit of the distributable income is distributed to the at least one participant during the benefit period.

19. The system of claim 15 wherein the at least one unit of distributable income is indicated by the denominated value of the at least one RIC.

20. The system of claim 15 wherein the RIC station is administered by an issuer.

21. The method of claim 1 wherein the floor portion is guaranteed.

22. The method of claim 1 wherein the floor portion is not guaranteed.

23. The method of claim 1 wherein the at least one self-liquidating and transferable denominated security is periodically valued by a valuation, accounting and pricing module.

24. The system of claim 10 wherein the at least one self-liquidating and transferable denominated security is periodically valued by a valuation, accounting and pricing module.

25. The system of claim 15 wherein the at least one self-liquidating and transferable denominated security is periodically valued by a valuation, accounting and pricing module.
